(19) United States
(12) Patent Application Publication
(10) Pub. No.: US 2010/0192974 A1
(43) Pub. Date: Aug. 5, 2010

(54) METHOD FOR ULTRASONIC CLEANING OF CONTAMINATION ATTACHED TO A SURFACE OF AN OBJECT

(75) Inventors: Youichirou MATSUMOTO, Tokyo (JP); Teiichirou IKEDA, Tokyo (JP); Shin YOSHIZAWA, Tokyo (JP); Terutaka SAHARA, Tokyo (JP); Nobuo TSUMAKI, Tokyo (JP); Yoshimitsu KITADA, Matsudo-shi (JP)

Correspondence Address: ROBERTS MLOTKOWSKI SAFRAN & COLE, P.C.;Intellectual Property Department, P.O. Box 10064, MCLEAN, VA, 22102-8064, US

(73) Assignees: HITACHI PLANT TECHNOLOGIES, LTD., Tokyo (JP); THE UNIVERSITY OF TOKYO, Tokyo (JP)

(21) Appl. No.: 12/756,504

(22) Filed: Apr. 8, 2010

Related U.S. Application Data
(62) Division of application No. 11/577,120, filed on Aug. 9, 2007.

(30) Foreign Application Priority Data
Oct. 12, 2004 (JP) 2004-298104

(51) Int. Cl. B08B 3/12

(52) U.S. Cl. 134/1.3; 134/1

(57) ABSTRACT

An ultrasonic cleaning method in which ultrasonic cleaning of a contamination attached to a surface of an object to be cleaned is performed by directing toward the object to be cleaned, a cleaning liquid to which ultrasonic waves are applied by alternately focusing first ultrasonic waves having a frequency of 1 to 10 MHz and second ultrasonic waves having a frequency equal to or lower than ½ of that of the first ultrasonic waves. A focus position adjustment device is used to adjust the distance of the focus position relative to the surface of the object to be cleaned, and a moving device is used to movie at least one of the ultrasonic wave generation device and a support base for the object so that the effect of the ultrasonic waves generated by the ultrasonic wave generation device on the surface of the object to be cleaned is uniform.

### CROSS REFERENCE TO RELATED APPLICATION

This application is a division of commonly owned, co-pending U.S. patent application Ser. No. 11/577,120, filed Aug. 9, 2007, which is a 371 of International Application No. PCT/JP2005/018515 filed Oct. 6, 2005.

### BACKGROUND OF THE INVENTION

The present invention relates to Method for ultrasonic cleaning and, more particularly, to Method for ultrasonic cleaning suitable for an object to be cleaned, such as a semiconductor substrate or a glass substrate for an LCD (liquid crystal display) or a photomask, which may have a scratch or damage at the time of cleaning as a quality defect detrimental to it.

### DESCRIPTION OF RELATED ART

As a cleaning method for removing contamination such as small particles attached to a semiconductor substrate or a glass substrate for an LCD or a photomask, brush-scrub cleaning comprising scrubbing an object to be cleaned with a rotating brush, high-pressure-jet cleaning comprising applying a cleaning liquid at a high pressure to an object to be cleaned and ultrasonic cleaning comprising applying to an object to be cleaned a cleaning liquid to which ultrasonic waves are applied are known. Among these cleaning methods, ultrasonic cleaning free from a dust generation problem as that with a rotating brush and superior in cleaning power than high-pressure-jet cleaning is most suitable and being widely used.

Two functions are known as contamination removal functions of ultrasonic cleaning. One of them is a physical cleaning function using cavitation impulse waves to separate and remove a contamination such as particles (solid material) attached to the surface of an object to be cleaned. The other is a chemical cleaning function using radicals generated by ultrasonic waves to decompose and remove a contamination. Effectively performing these two function is a point in improving the effect of ultrasonic cleaning. As the effects of these physical cleaning and chemical cleaning, higher effects can be obtained if the power of applied ultrasonic waves is higher. In actuality, however, conventional ultrasonic cleaning apparatuses are incapable of irradiating an object to be cleaned with ultrasonic wave energy higher than that radiated per unit surface area from an ultrasonic vibrator and do not have satisfactorily high cleaning.

The applicant of the present invention has developed, as a technique using ultrasonic waves, and an ultrasonic wave irradiation apparatus capable of locally obtaining high ultrasonic wave energy. It is possible to pulverize calculi, such as renal calculus, urinary calculus and biliary calculus, more effectively by using this ultrasonic wave irradiation apparatus (Japanese Patent Laid-Open No. 2004-33476 and corresponding U.S. Patent Application Publication 2005/202694).

Application of the ultrasonic wave irradiation apparatus disclosed in Japanese Patent Laid-Open No. 2004-33476 and corresponding U.S. Patent Application Publication 2005/202694 to the above-described cleaning of a semiconductor substrate or a glass substrate, however, requires a further improvement in the apparatus arrangement.

That is, in the case of cleaning of a semiconductor substrate or a glass substrate, it is extremely important to avoid scratching or damaging the surface of the semiconductor substrate or glass substrate by ultrasonic wave energy at the time of cleaning as well as to achieve a high cleaning effect. In particular, in a case where a fine pattern is formed in a semiconductor substrate surface or a glass substrate surface, it is necessary to perform ultrasonic cleaning so as not to break the fine pattern.

### SUMMARY OF THE INVENTION

The present invention has been achieved under these circumstances, and an object of the present invention is to provide a method for ultrasonic cleaning capable of effectively removing particles, an organic contamination or the like attached to the surface of an object to be cleaned without scratching or damaging the surface of the object to be cleaned.

To achieve the above-described object, according to a first aspect of the present invention, there is provided a method for ultrasonic cleaning which performs ultrasonic cleaning of a contamination attached to the surface of an object to be cleaned, by using a cleaning liquid to which ultrasonic waves are applied, the method using a cleaning bath with a pool of the cleaning liquid, a support base on which the object to be cleaned is supported in the cleaning liquid, an ultrasonic wave generation device of alternately focusing first ultrasonic wave having a frequency of 1 to 10 MHz and a second ultrasonic wave having a frequency equal to or lower than ½ of that of the first ultrasonic wave toward the object to be cleaned, a focus position adjustment device of adjusting a distance between a focus position for the focusing and the surface of the object to be cleaned, and a moving device of moving at least any one of the ultrasonic wave generation device and the support base so that the effect on the surface of the object to be cleaned of the ultrasonic waves generated by the ultrasonic wave generation device is uniform.

The first aspect relates to method using a dip type apparatus for performing ultrasonic cleaning on the object to be cleaned in a state of being immersed in the cleaning liquid. According to the first aspect, an ultrasonic vibrator is arranged in the ultrasonic cleaning apparatus so that ultrasonic waves generated from the ultrasonic wave generation device are focused on a dot or a local portion in line form on or in the vicinity or the surface of the object to be cleaned, or an ultrasonic vibrator having a concave surface is provided as an ultrasonic wave generation source in the ultrasonic cleaning apparatus. The object to be cleaned is supported on the support base in the cleaning bath. Ultrapure water, for example, is used as the cleaning liquid. However, the cleaning liquid is not specifically limited to ultrapure water. A suitable liquid may be selected according to the kind of a contamination on the object to be cleaned. In this state, first ultrasonic waves having a frequency of 1 to 10 MHz are emitted from the ultrasonic wave generation device to locally generate a cluster of a multiplicity of bubbles by cavitation at the focus position to which the ultrasonic waves are focused. Subsequently, second ultrasonic waves having a frequency equal to or lower than that of the first ultrasonic waves are emitted from the ultrasonic wave generation device to cause the bubbles generated by the first ultrasonic waves to resonate and collapse. The position to which the first ultrasonic waves are focused and the position to which the second ultrasonic waves are focused are the same. Collapse of bubbles refers not to a process in which bubbles become fragmented or disappear but to a phenomenon in which when bubbles implode by a change in ambient pressure, high energy is concentrated in the vicinity of the center of the cluster of bubbles to generate an extremely large pressure impulse wave.

The first and second ultrasonic waves are thus focused to the focus position to locally concentrate high energy at the time of bubble collapse. It is, therefore, possible to remove even extremely strongly attached particles by alternately repeating the above-described radiation of the first ultrasonic waves and radiation of the second ultrasonic waves. After emission of the first ultrasonic waves for 30 to 70 μs, the second ultrasonic waves are successively emitted for 5 to 15 μs. It is preferable to repeatingly perform this radiation at intervals of 80 to 120 μs.

In the above-described ultrasonic cleaning of the object to be cleaned, the distance between the focus position and the surface of the object to be cleaned can be adjusted by the focus position adjustment device, thus making it possible to set the optimum focus point as desired according to the kind of a contamination on the object to be cleaned, the strength of attachment of the contamination and the physical strength of the surface of the object to be cleaned (hardness against scratching or damaging). The distance between the focus point and the surface of the object to be cleaned adjusted by the focus position adjustment device comprises zero. That is, adjustment is performed so that the focus position is between the surface of the object to be cleaned and a position in the vicinity of the surface.

The cleaning liquid has radicals (e.g., OH radical) generated at the focus position by receiving irradiation with the ultrasonic waves. An organic contamination attached to the surface of the object to be cleaned is oxidatively decomposed. Also in this case, energy necessary for generation of radicals can be concentrated on a local region by focusing the first and second ultrasonic waves to the focus position, thus generating radicals with efficiency. Moreover, since the distance between the focus position and the surface of the object to be cleaned can be adjusted by the focus position adjustment device, the optimum focus position can be set as desired according to the kind of an organic contamination, the strength of attachment of the contamination and the chemical strength (resistance to radicals) of the surface of the object to be cleaned.

Therefore, even on a semiconductor substrate or glass substrate on which a fine pattern for a metal thin film or a circuit, for example, is formed in advance, ultrasonic cleaning can be performed effectively without damaging the fine pattern.

According to the present invention, the moving device of moving at least any one of the ultrasonic wave generation device and the support base enables ultrasonic cleaning to be uniformly performed on the surface of the object to be measured, and changes the moving speed to enable finely-controlled cleaning in such a manner that the moving speed is reduced with respect to a surface portion having a higher degree of contamination, and is increased with respect to a surface portion having a lower degree of contamination.

To achieve the above-described object, according to a second aspect of the present invention, there is provided a method for ultrasonic cleaning which performs ultrasonic cleaning of a contamination attached to a surface of an object to be cleaned, by using a cleaning liquid to which ultrasonic waves are applied, the method using a transport device to transport the object to be cleaned, an ultrasonic wave nozzle provided above the transport device, the ultrasonic wave nozzle ejecting the cleaning liquid from a nozzle opening toward the surface of the object to be cleaned, the ultrasonic wave nozzle having an ultrasonic wave generation device that alternately focuses first ultrasonic waves having a frequency of 1 to 10 MHz and second ultrasonic waves having a frequency equal to or lower than ½ of that of the first ultrasonic waves toward the surface of the object to be cleaned and a focus position adjustment device that adjusts the distance between the nozzle opening and the surface of the object to be cleaned.

The second aspect relates to use of an ultrasonic nozzle type apparatus for applying ultrasonic waves to the cleaning liquid ejected from the nozzle opening toward the object to be cleaned.

Also in the case of the ultrasonic nozzle type in the second aspect, the function and effect are the same as those in the case of the dip type method of the first aspect.

According to a third aspect of the present invention, the object to be cleaned in the first or second aspect is any one of a semiconductor substrate or a glass substrate for an LCD or a photomask.

This is because the ultrasonic cleaning method of the present invention is particularly effective in cleaning on an object to be cleaned, such as a semiconductor substrate or a glass substrate for an LCD or a photomask, which may have a scratch or damage at the time of cleaning as a quality defect detrimental to it.

According to a fourth aspect of the present invention, a solid member is provided at the focus position in one of the first to third aspects.

Bubbles can occur extremely easily on the surface of a solid member. Therefore, a cluster of bubbles can be formed at a higher density by providing a solid member at the ultrasonic wave focus position, as in the fourth aspect. In this way, higher energy can be obtained at the time of bubble collapse. Also, even if the ultrasonic wave generation power is low, bubbles can be generated with efficiency, thus achieving an energy saving effect.

According to a fifth aspect of the present invention, the solid member in the fourth aspect is any one of a metallic plate, a flat plate made of a material other than metal, a mesh plate and a porous plate.

This is a preferred example of a solid member capable of promoting generation of bubbles. A metallic plate, e.g., an ultrasonic wave reflecting plate, a flat plate made of a material other than metal, a mesh plate or a porous plate can be suitably used. In such a case of using a metallic plate or a flat plate, it is preferable to place the plate so that its surface is parallel to the direction of travel of ultrasonic waves in order to avoid impeding the flow of energy at the time of collapse of bubbles in reaching the object to be cleaned. In the case of a mesh plate or a porous plate not impeding the flow of energy at the time of collapse of bubbles in reaching the object to be cleaned, the plate can be placed so that its surface is perpendicular to the direction of travel of ultrasonic waves.

According to a sixth aspect of the present invention, the direction of travel of the ultrasonic waves is inclined relative to a direction that is perpendicular to the surface of the object to be cleaned in the first, third, fourth or fifth aspect.

The sixth aspect relates to a dip type method. Since the direction of travel of ultrasonic waves is inclined relative to a direction perpendicular to the surface of the object to be cleaned, the region in which ultrasonic waves are effective and the region in which radicals generated by the ultrasonic waves are effective on the surface of the object to be cleaned can be increased in size. Further, the direction of the flow caused by an acoustic flow can be set in a direction to enable a contamination removed from the surface of the object to be cleaned to be quickly expelled from the object to be cleaned, thus improving the cleaning effect. “Acoustic flow” refers to a flow of a medium caused in the beam of ultrasonic waves propagating through the fluid.

According to a seventh aspect of the present invention, the direction of ejection of the cleaning liquid from the nozzle opening and the direction of travel of the ultrasonic waves are inclined relative to a direction perpendicular to the surface of the object to be cleaned in any one of the second to fifth aspects.

The seventh aspect relates to use of an ultrasonic wave type nozzle. Since the direction of ejection of the cleaning liquid from the nozzle opening and the direction of travel of the ultrasonic waves are inclined from a direction perpendicular to the surface of the object to be cleaned, the region in which ultrasonic waves are effective and the region in which radicals generated by the ultrasonic waves are effective on the surface of the object to be cleaned can be increased in size. Further, the direction in which the cleaning liquid ejected from the nozzle opening flows on the surface of the object to be cleaned and the direction of the flow caused by an acoustic flow can be set in one direction to enable a contamination removed from the surface of the object to be cleaned to be quickly expelled from the object to be cleaned, thus improving the cleaning effect.

According to an eighth aspect of the present invention, a pair of the ultrasonic wave generation devices are provided and are disposed so as to have a common ultrasonic wave focus position in any one of the first to seventh aspects.

This arrangement enables generation of bubbles in a region made narrower than the ultrasonic focus region formed by one ultrasonic wave generation device, and thereby makes it possible to obtain higher energy at the time of collapse of bubbles.

According to a ninth aspect of the present invention, the pair of ultrasonic wave generation devices in the eighth aspect are supported so as to be rotatable on a rotation axis, and the focus position adjustment device in the eight aspect adjusts the distance between the common focus position and the surface of the object to be cleaned by rotating the pair of ultrasonic wave generation devices while maintaining the common focus position.

Since the pair of ultrasonic wave generation devices in the eighth aspect are supported so as to be rotatable on a rotation axis, and are rotated by the focus position adjustment device, the ultrasonic waves from the two ultrasonic wave generation device can be easily and accurately focused to the common focus position, and the distance between the focus position and the surface of the object to be cleaned can be adjusted.

According to a tenth aspect of the present invention, gas dissolved water blow-in device is used to blow water in which a gas is dissolved into the cleaning liquid is provided in any one of the first to ninth aspects.

This is because the cleaning liquid having gas dissolved water blown thereinto has an increased amount of generation of radicals by irradiation with ultrasonic waves in comparison with a cleaning liquid having no gas dissolved water blown thereinto to further improve the effect of cleaning the object to be cleaned by radicals. In this case, it is preferred that a blow-in port be disposed in the vicinity of the focus position and on the upstream side of the focus position with respect to the direction of travel of ultrasonic waves to eject gas toward the focus position. The gas or gas dissolved water blown in on the upstream side of the focus position generates radicals efficiently at the focus position in which the ultrasonic energy is the largest, and the radicals generated then reach the surface of the object to be cleaned with efficiency.

According to an eleventh aspect of the present invention, a gas blow-in device is used to blow a gas into the cleaning liquid is provided in any of the first to ninth aspects.

Blowing the gas directly into the cleaning liquid may be performed instead of blowing gas dissolved water into the cleaning liquid.

As described above, the ultrasonic cleaning method of the present invention can effectively remove particles, an organic contamination and the like attached to the surface of an object to be cleaned without scratching or damaging the surface. Therefore, the present invention is highly effective in ultrasonic cleaning of semiconductor substrates and glass substrates for LCDs and photomasks.

### BRIEF DESCRIPTION OF THE DRAWINGS

FIG. 1 is a diagram schematically showing the entire construction of a dip-type ultrasonic cleaning apparatus used in the method of the present invention in a case where the position to which ultrasonic waves are focused is on the surface of a glass substrate;

FIG. 2A is a diagram for explaining the mechanism of ultrasonic cleaning in the present invention;

FIG. 2B is a diagram for explaining the mechanism of ultrasonic cleaning in the present invention;

FIG. 3 is a schematic diagram of another form of the dip-type ultrasonic cleaning apparatus used in the method of the present invention in a case where the ultrasonic wave focus position is set apart from the surface of the glass substrate;

FIG. 4A is a diagram for explaining a solid member provided at the ultrasonic wave focus position;

FIG. 4B is a diagram for explaining a solid member provided at the ultrasonic wave focus position;

FIG. 5 is a schematic diagram of still another form of the dip-type ultrasonic cleaning apparatus used in the method of the present invention in a case where ultrasonic wave generation device is inclined relative to a direction perpendicular to the glass substrate;

FIG. 6 is a schematic diagram of a further form of the dip-type ultrasonic cleaning apparatus used in the method of the present invention in a case where two ultrasonic wave generation device are provided;

FIG. 7 is a schematic diagram of still a further form of the dip-type ultrasonic cleaning apparatus used in the method of the present invention in a case where two ultrasonic wave generation device are provided, and where gas dissolved water is blown into the cleaning liquid;

FIG. 8 is a schematic diagram of still a further form of the dip-type ultrasonic cleaning apparatus used in the method of the present invention in a case where two ultrasonic wave generation device are provided, and where gas is directly blown into the cleaning liquid;

FIG. 9 is a diagram schematically showing the entire construction of an ultrasonic-wave-nozzle-type ultrasonic cleaning apparatus used in the method in a case where the ultrasonic wave focus position is on the surface of a glass substrate;

FIG. 10 is a diagram schematically showing the entire construction of another form of the ultrasonic-wave-nozzle-type ultrasonic cleaning apparatus used in the method of the present invention in a case where the ultrasonic wave focus position is set apart from the surface of a glass substrate;

FIG. 11 is a schematic diagram of still another form of the ultrasonic-wave-nozzle-type ultrasonic cleaning apparatus used in the method of the present application in a case where ultrasonic wave generation device is inclined relative to a direction perpendicular to the glass substrate;

FIG. 12 is a schematic diagram of a further form of the ultrasonic-wave-nozzle-type ultrasonic cleaning apparatus used in the method of the present application in a case where two ultrasonic wave generation device are provided; and

FIG. 13 is a schematic diagram of still a further form of the ultrasonic-wave-nozzle-type ultrasonic cleaning apparatus used in the method of the present application in a case where two ultrasonic wave generation device are provided, and where gas is blown into the cleaning liquid.

### DETAILED DESCRIPTION OF THE PRESENT INVENTION

A preferred embodiment of the method for ultrasonic cleaning in accordance with the present invention will be described with reference to the accompanying drawings.

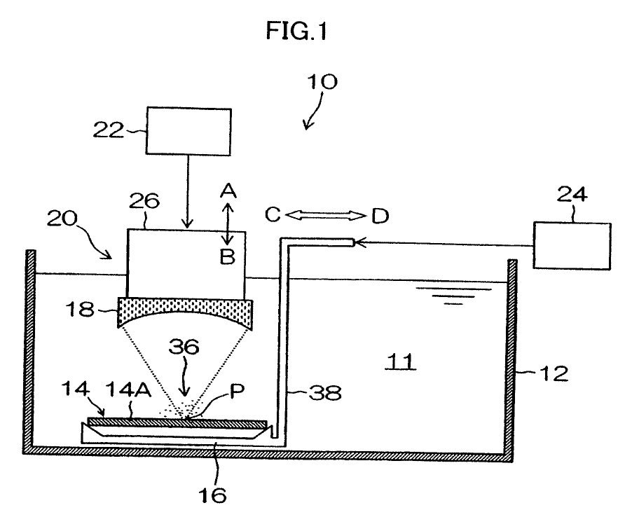

FIGS. 1 to 7 are diagrams schematically showing the first embodiment of the ultrasonic cleaning method of the present invention using various arrangements of a dip type bath for ultrasonic cleaning of an object in a state of being immersed in a cleaning liquid. In the following description, the object to be cleaned is a glass substrate by way of example only.

As shown in FIG. 1, the dip-type ultrasonic cleaning apparatus 10 has as its main sections a cleaning bath 12 pooling a cleaning liquid 11, a support base 16 on which a glass substrate 14 is supported in the cleaning liquid 11, and an ultrasonic vibrator 18 capable of focusing ultrasonic waves, and is constituted by an ultrasonic wave generation device 20 for alternately focusing ultrasonic waves of different frequencies toward a surface 14A of the glass substrate 14, a focus position adjustment device 22 for adjusting the distance between an ultrasonic wave focus position P and the surface 14A of the glass substrate 14, and a moving device 24 for moving the support base 16 so that the effect on the surface 14A of the substrate 14 of ultrasonic waves produced by the ultrasonic wave generation device 20 is uniform. While in this embodiment the moving device 24 moves the support base 16, the moving device 24 may move the ultrasonic wave generation device 20 or both the support base 16 and the ultrasonic wave generation device 20.

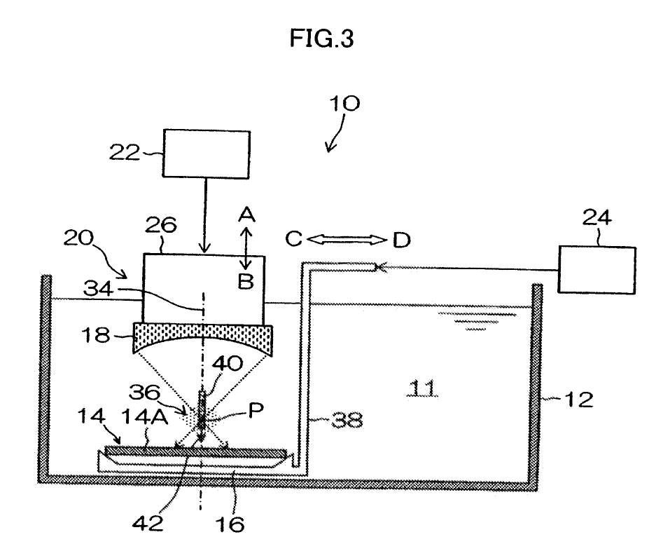

The ultrasonic wave generation device 20 is constituted mainly by a main body 26 and the ultrasonic vibrator 18. The ultrasonic vibrator 18 has a concave vibrating surface and is disposed so that radiated ultrasonic waves are focused toward the glass plate 14 supported on the support base 16. Ultrasonic waves may be focused in spot form (dot-like form) or line form (linear form). In this embodiment, however, ultrasonic waves are focused in line form (see FIGS. 4A and 4B), and the line width is set equal to or larger than the size of the glass substrate 14 in the widthwise direction (in the front-rear direction in FIG. 1). As the ultrasonic vibrator 18 radiating focused ultrasonic waves, a concave surface piezoelectric element for example may be used.

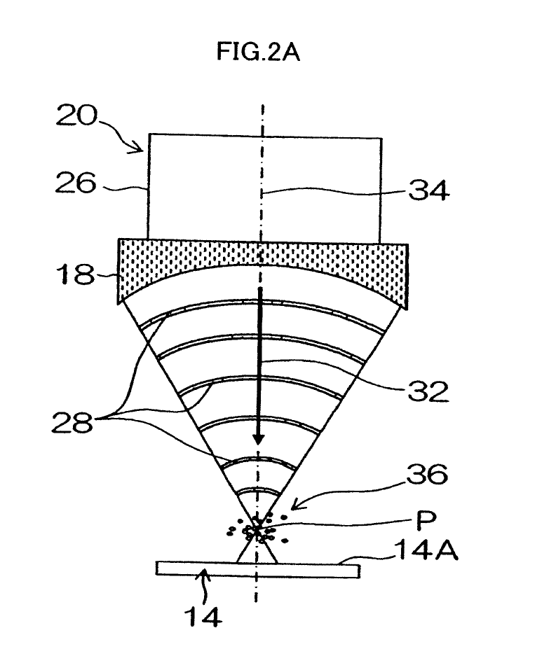

As shown in FIGS. 2A and 2B, a signal is supplied from a frequency-controllable oscillator (not shown) housed in the main body 26 to the ultrasonic vibrator to radiate first ultrasonic waves 28 at a higher frequency of, for example, 2 MHz for about 50 μs (FIG. 2A) and to successively radiate second ultrasonic waves 30 at a lower frequency equal to or less than a half of the frequency of the first ultrasonic waves, for example, about 500 kHz for about 10 μs (FIG. 2B). This radiation of the first and second ultrasonic waves 28 and 30 is assumed to be one cycle and this cycle of radiation is repeatedly performed at short time intervals of about 100 μs. In this case, it is preferred that the frequency of the first ultrasonic waves 28 be in the range from 1 to 10 MHz, and that the frequency of the second ultrasonic waves 30 be ½ or less of that of the first ultrasonic waves. The time period during which the first ultrasonic waves 28 is radiated in one cycle is in the range from 30 to 70 μs, and the second ultrasonic waves 30 is radiated in one cycle is in the range from 5 to 15 μs. It is also preferred that the period of the interval time be in the range of 80 to 120 μs. Arrow 32 in FIGS. 2A and 2B indicates the direction in which ultrasonic waves travel. Dot-dash line 34 indicates a center line of ultrasonic waves 28 and 30 traveling in the direction of arrow 32 while being focused.

By the above-described radiation of the first ultrasonic waves 28, fine bubbles 36 are generated at a high density at a local focus position P on the surface 14A of the glass substrate 14 or in the vicinity of the surface 14A. The generated bubbles 36 are collapsed in a short time by the second ultrasonic waves successively radiated. Impactive force at this time is much larger than that in the case of the conventional art in which ultrasonic waves are not focused, and is effective in removing fine particles and a contamination in film form, which are attached to the surface of 14A of the glass substrate 14, and which cannot be removed by the conventional art. Also, radicals can be generated effectively by the large impactive force, thus improving the effect of chemical cleaning by radicals.

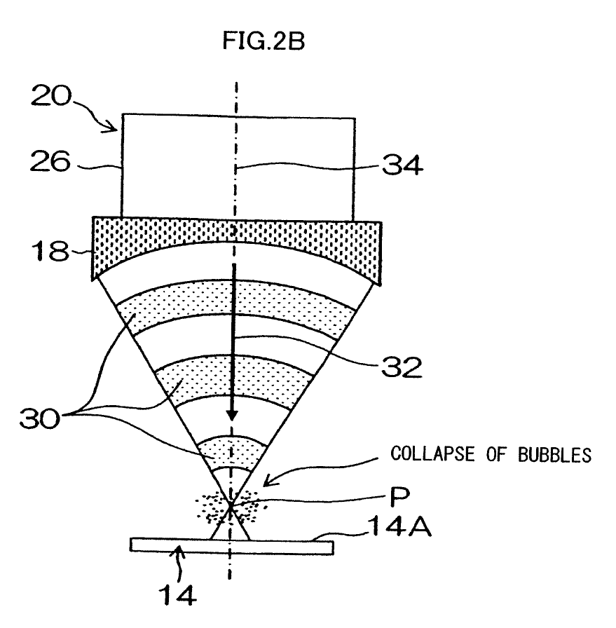

The main body 26 of the ultrasonic wave generation device 20 is supported by the focus position adjustment device 22 movably in arrow A-B directions shown in FIG. 1, thereby enabling the position P to which ultrasonic waves 28 or 30 are focused to be set on the surface 14A of the glass substrate 14 as shown in FIG. 1 or apart from the surface 14A of the glass substrate 14 as shown in FIG. 3. The construction of the focus position adjustment device 22, not specifically illustrated, may be such that the main body 26 is slidably supported on a vertically-set support column by means of a nut member, the nut member is screwed around a ball screw, and the ball screw is rotated by a reversible motor. In short, use of an adjustment device having a mechanism capable of moving the ultrasonic wave generation device 20 in arrow A-B directions indicated in FIG. 1 may suffice as the focus position adjustment device 22. The focus position adjustment device 22 is thus provided to enable adjustment of the distance between the focus position P and the surface 14A of the glass substrate 14 and, hence, free setting of the optimum focus position P according to the kind of contamination attached to the glass substrate 14, the strength of attachment, the physical strength of the surface 14A of the glass substrate 14 (hardness against scratching or damaging) and the chemical strength (resistance to radicals).

The position P of focusing of ultrasonic waves 28 and 30 is suitably set apart from the surface 14A of the glass substrate 14 as shown in FIG. 3, thereby ensuring that even in the case of ultrasonic cleaning on a glass substrate 14 which can be easily affected by an impactive force produced by collapse of bubbles 36, e.g., a glass substrate on which a metal thin film is formed or a glass substrate on which a fine circuit pattern or the like is formed, ultrasonic cleaning can be performed so as not to damage the metal thin film or the fine pattern. The set-apart distance from the surface 14A of the glass substrate 14 depends on various conditions relating to the glass substrate 14 to be cleaned. It is, therefore, preferable to grasp a suitable set-apart distance through a preliminary test or the like.

As shown in FIG. 1, the support base 16 for supporting the glass substrate 14 is connected to the moving device 24 by an arm 38 and is arranged so as to be movable in arrow C-D directions. Thus, ultrasonic cleaning can be uniformly performed on the surface 14A of the glass substrate 14 moved together with the support base 16 by alternately focusing the first and second ultrasonic waves 28 and 30 in line form toward the glass substrate 14 so that the generation and collapse of bubbles recur. A device or a mechanism usable as the moving device is, for example, a cylinder device which moves the arms through strokes in the arrow C-D directions, for example, by extending and contracting a cylinder rod, or a ball screw mechanism which reciprocates the arm in the arrow C-D directions by a ball screw, which device or mechanism is not specifically illustrated. Since bubbles are generated much on a solid material surface, it is preferable to provide a solid member 40 at the position P of focusing of ultrasonic waves 28 and 30, as shown in FIG. 3.

FIG. 3 shows a case where a metallic plate (ultrasonic wave reflecting plate) having a thickness sufficiently small in comparison with the wavelength of ultrasonic waves used is provided at on the above-mentioned center line 34 at the position P of focusing of ultrasonic waves 28 and 30. The metallic plate can be made not obstructive to reaching of generated bubbles to the glass substrate 14 by setting the surface of the metallic plate parallel to as ultrasonic wave travel direction 32, as shown in FIG. 4A. The solid member 40 is provided at the position P of focusing of ultrasonic waves 28 and 30 in this way to promote the generation of bubbles by the first ultrasonic waves 28 to form bubbles 36 at a high density, thus obtaining increased energy at the time of collapse of bubbles 36. Also, a large amount of radicals generated by collapse of bubbles 36 are transported to the surface 14A of the glass substrate 14 by an acoustic flow 42 of ultrasonic waves 28 and 30 to chemically decompose and remove by radicals an organic contamination attached to the surface 14A.

The solid member 40 provided at the position P of focusing of ultrasonic waves 28 and 30 is not limited to the metallic plate. A flat plate made of any other material, e.g., a ceramic or a plastic may alternatively be provided. Also, a metallic meshwork having a multiplicity of openings or a porous plate made of any of various materials may alternatively be used, as shown in FIG. 4B. Since a metallic meshwork or a porous plate allows bubbles and the cleaning liquid to pass therethrough and thereby enables supply of the bubbles and the cleaning liquid to the position on the glass substrate 14, it can be set along a direction perpendicular to the direction 32 of travel of ultrasonic waves 28 and 30. In such a case, it is preferable to set the diameter of wires forming the metallic meshwork and the size of the openings or the pitch of pores in the porous plate to a value sufficiently smaller than the wavelength of the ultrasonic waves, e.g., 0.5 mm or less in order to sufficiently supply bubbles and the cleaning liquid to the substrate 14 while ensuring the generation of bubbles at the surface of the solid member.

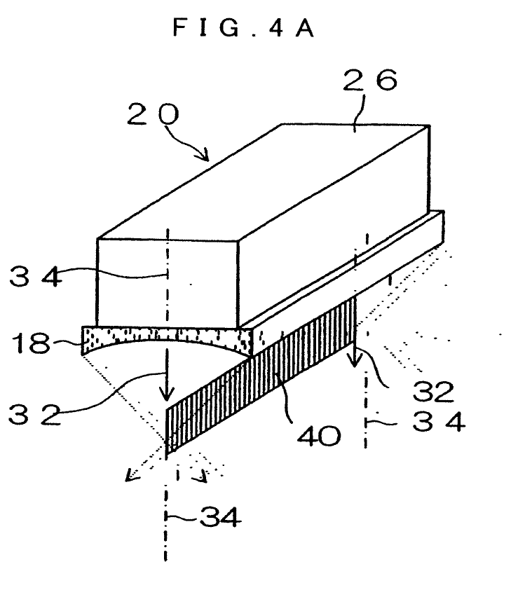

Referring to FIG. 5, while the position P of focusing of ultrasonic waves 28 and 30 is set apart from the surface 14A of the glass substrate 14, the direction 32 of travel of ultrasonic waves 28 and 30 is set at an angle of 30° from a direction perpendicular to the glass substrate 14. The direction 32 of travel of ultrasonic waves 28 and 30 is thus inclined from a direction perpendicular to the surface 14A of the glass substrate 14 to enable the region in which ultrasonic waves are effective and the region in which radicals produced by the ultrasonic waves are effective on the surface 14A of the substrate 14 to be increased in size. Further, the direction of the flow caused by the acoustic flow 42 can be set in one direction to enable a contamination removed from the surface 14A of the glass substrate 14 to be quickly expelled from the glass substrate 14, thus improving the cleaning effect. The angle (α) of the inclination is preferably in the range from 10 to 80°, more preferably in the range from 50 to 70°. This is because if the angle (α) is smaller than 10°, the desired effect of increasing the region in which ultrasonic waves 28 and 30 are effective cannot be obtained, and because if the angle (α) exceeds 80°, the effective region becomes excessively increased and the ultrasonic cleaning effect is reduced.

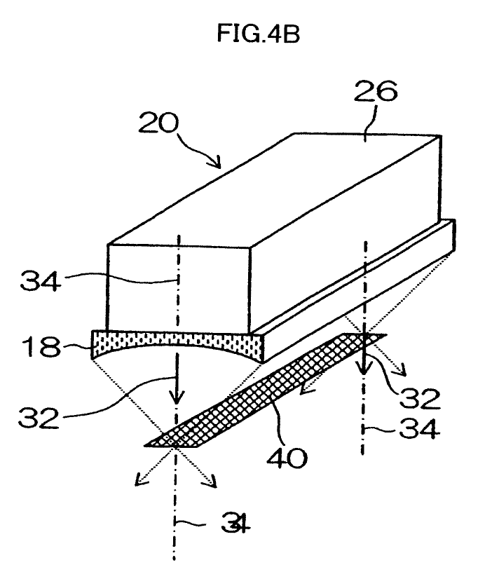

FIG. 6 shows an example of an arrangement in which two ultrasonic vibrators 18 are disposed so that the angle from the horizontal (β) can be changed, and so that ultrasonic waves from the two ultrasonic vibrators 18 are focused to one point. The angle from the horizontal (β) refers to the angle of direction 32 of travel of ultrasonic waves 28 and 30 from the horizontal surface 14A of the glass substrate 14.

Since ultrasonic waves from the two ultrasonic vibrators 18 are focused to one point, the main body 26 of each ultrasonic wave generation device 20 is supported so as to be movable (in E-F directions) on the circumference of a circle whose radius corresponds to the distance L between the ultrasonic wave generation surface of the ultrasonic vibrator 18 and the focus position P. This arrangement enables the angle from the horizontal (β) to be freely changed without changing the focus position P. The optimum value of the angle from the horizontal (β) varies depending on the object to be cleaned but falls generally into a range of 45°±30°. The distance between the position P of focusing of ultrasonic waves and the object to be cleaned, i.e., the substrate 14, by moving a structure 26B along the top-bottom direction on which the two ultrasonic wave generation device 20 are supported, or by moving the substrate 14 along the top-bottom direction. Thus, two ultrasonic wave generation devices 20 are provided and the positions P of focusing therefrom are set to a common point, thereby enabling generation of a larger amount of bubbles 36 in a restricted region in the vicinity of the ultrasonic wave focus region. As a result, further increased energy can be obtained at the time of collapse of bubbles 36.

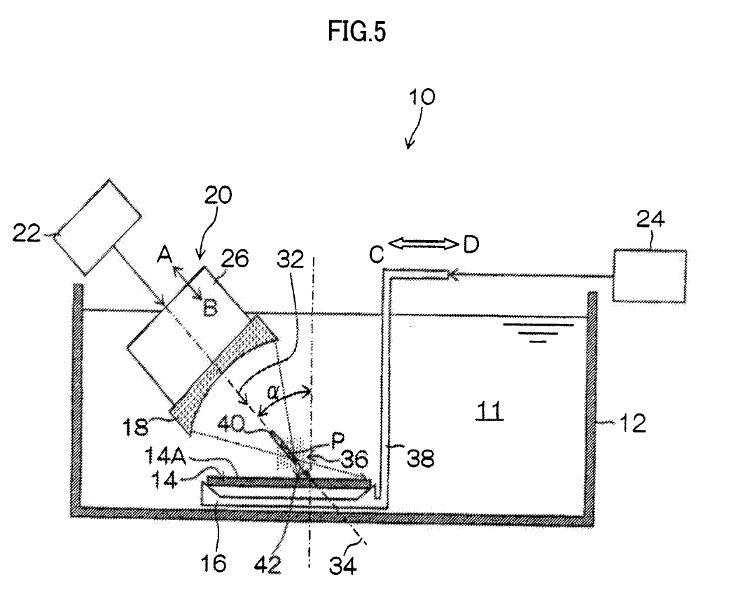

FIG. 7 shows an ultrasonic cleaner 10 in which two ultrasonic wave generation device 20 are provided and a blow-in port 46 is also provided through which a gas or gas dissolved water is blown into the cleaning liquid in the vanity of the focus position P. As the gas to be blown in, a gas such as hydrogen gas or argon gas from which radicals can be easily generated by ultrasonic waves 28 and 30 is preferred. In this a case, the gas may be directly blown into the cleaning liquid 11. However, it is more preferable to supply into the cleaning liquid 11 gas dissolved water in which the gas is dissolved. Referring to FIG. 7, the apparatus is arranged to supply gas dissolved water; a gas dissolving device 48 using a hollow-fiber membrane is provided outside the cleaning bath 12. Ultrapure water from which any dissolved gas has been removed by degassing processing in advance is supplied to the gas dissolving device 48 through a liquid introduction pipe 50, while hydrogen gas is supplied thereto through a gas supply pipe 52. Gas dissolved water is produced by dissolving hydrogen gas in the ultrapure water. The gas dissolved water is blown into the cleaning bath 12 through the blow-in port 46 of a gas supply pipe 54. Blowing in of the gas into the cleaning liquid 11 is not limited to the two ultrasonic wave generation devices 20. It can also be applied to the one ultrasonic wave generation device 20 described above with reference to FIGS. 1 to 6.

Thus, the cleaning liquid 11 having a gas blown therein in the vicinity of the focus position P has an increased amount of generation of radicals by irradiation with ultrasonic waves 28 and 30 in comparison with a cleaning liquid having no gas blown thereinto, thereby further improving the effect of cleaning the glass substrate 14 by radicals. In this case, it is preferred that the blow-in port 46 be disposed in the vicinity of the focus position P and on the upstream side of the focus position P with respect to the direction 32 of travel of ultrasonic waves 28 and 30 to eject the gas or gas dissolved water toward the focus position P. The gas blown in on the upstream side of the focus position P becomes radicals efficiently at the focus position P at which ultrasonic wave energy is maximized, and the radicals then reach the surface 14A of the glass substrate 14.

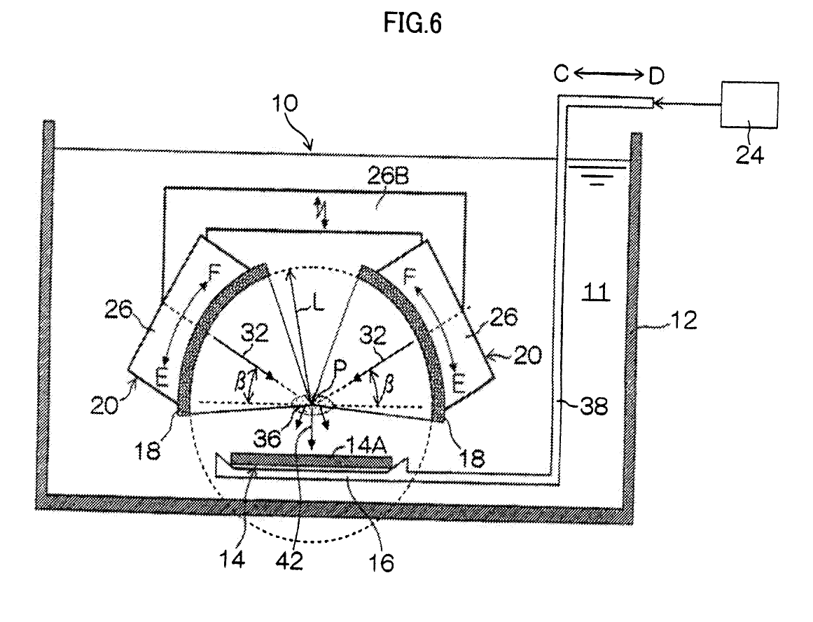

FIG. 8 shows the ultrasonic cleaner 10 in FIG. 7 with an arrangement in which a gas is directly blown into the cleaning bath 12 instead of gas dissolved water (in the case shown in FIG. 8, hydrogen gas is blown in). Also in this case, the same effect as that in the case of blowing in gas dissolved water can be obtained.

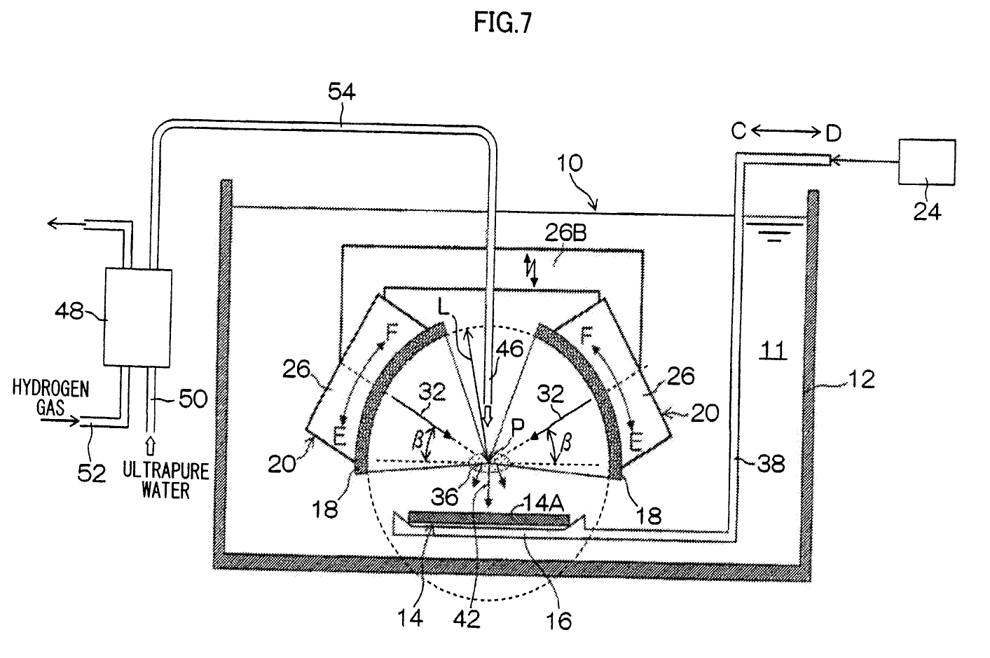

FIGS. 9 to 13 show a second embodiment of the ultrasonic cleaning method of the present invention using various forms of an ultrasonic wave type nozzle for applying ultrasonic waves to a cleaning liquid ejected through a nozzle opening toward an object to be cleaned. The same members or devices as those in the first embodiment will be described with reference to the same reference characters.

As shown in FIG. 9, the method uses an ultrasonic cleaning apparatus 100 of an ultrasonic wave nozzle type that is comprised mainly of a transport device 102 for transporting a glass substrate 14, an ultrasonic nozzle 108 which is provided above the transport device 102, which effects a cleaning liquid 11 toward a surface 14A of the glass substrate 14 through a nozzle opening 104, and which has a ultrasonic wave generation device 20 for alternately focusing ultrasonic waves of difference frequencies toward the surface 14A of the glass substrate 14, and a focus position adjustment device 22 for adjusting the distance between the nozzle opening 104 and the surface 14A of the glass substrate 14.

The ultrasonic nozzle 108 is constituted mainly by a main body 26, an ultrasonic vibrator 18 and a nozzle container 110 having the nozzle opening 104 in the form a slit whose longitudinal direction corresponds to the width direction of the glass substrate 14 (the front-rear direction of FIG. 9). The ultrasonic vibrator 18 is disposed on a ceiling surface of the nozzle container 110, and a cleaning liquid supply pipe 112 through which the cleaning liquid 11 is supplied is connected in a side surface. The ultrasonic vibrator 18 has a concave vibrating surface and is disposed so that the radiated ultrasonic waves 28 and 30 as those described above with respect to the first embodiment are focused toward the glass plate 14. In this case, ultrasonic waves 28 and 30 are focused in line form along the nozzle opening 104 in slit form. As the transport device 102 for transporting the glass substrate 14, a roller conveyer device in which drive rollers 114 are arranged as shown in FIG. 9 is preferably used. The transport device 102, however, is not limited to this. In the case of the ultrasonic-wave-nozzle-type ultrasonic cleaning apparatus 100, the cleaning liquid 11 ejected from the nozzle opening 104 cleans the surface 14A of the glass substrate 14, and thereafter, falls into a receptacle (not shown) provided below the transport device 102. Therefore, a transport device 102 through which the cleaning liquid 11 can fall easily is preferred.

In the method using the ultrasonic-wave-nozzle-type ultrasonic cleaning apparatus 100, the cleaning liquid 11 is supplied to the nozzle container 110 and ejected toward the glass substrate 14 through the nozzle opening 104, while a signal is supplied from a frequency-controllable oscillator (not shown) housed in the main body 26 to the ultrasonic vibrator 18 to radiate the first ultrasonic waves 28 at a higher frequency of, for example, 2 MHz for about 50 μs and to successively radiate the second ultrasonic waves 30 at a lower frequency equal to or less than a half of the frequency of the first ultrasonic waves, for example, about 500 kHz for about 10 μs. This cycle of radiation is repeatedly performed at short time intervals of about 100 μs. Thus, also in the case of using the ultrasonic-wave-nozzle-type ultrasonic cleaning apparatus 100, the same ultrasonic cleaning effect as that of the method using the dip-type ultrasonic cleaning apparatus 10 can be obtained. In this case, preferable ranges of the time period during which the first ultrasonic waves 28 and the second ultrasonic wave 30 are radiated at one time, and the time intervals are the same as those in the first embodiment.

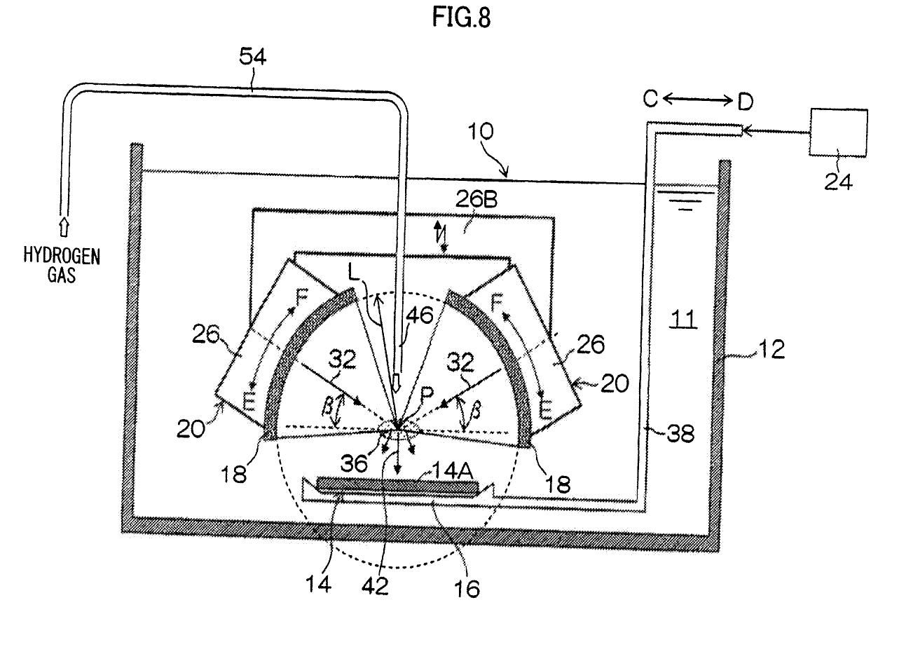

The ultrasonic nozzle 108 can be moved in arrow A-B directions by the focus position adjustment device 22 to bring the nozzle opening 104 and the focus position P to a position substantially touching the surface 14A of the glass substrate 14 as shown in FIG. 9 or to set apart from the surface 14A of the glass substrate 14 as shown in FIG. 10. As the focus position adjustment device 22, a ball screw mechanism, e.g., the one described above with respect to the first embodiment can be used. The same function and effect as those described with respect to the first embodiment can be obtained thereby. Therefore, even in the case of ultrasonic cleaning of a glass substrate 14 which can be easily affected by an impactive force produced by collapse of bubbles 36, e.g., a glass substrate 14 on which a metal thin film is formed or a glass substrate 14 on which a fine circuit pattern or the like is formed, ultrasonic cleaning can be performed so as not to damage the metal thin film or the fine pattern.

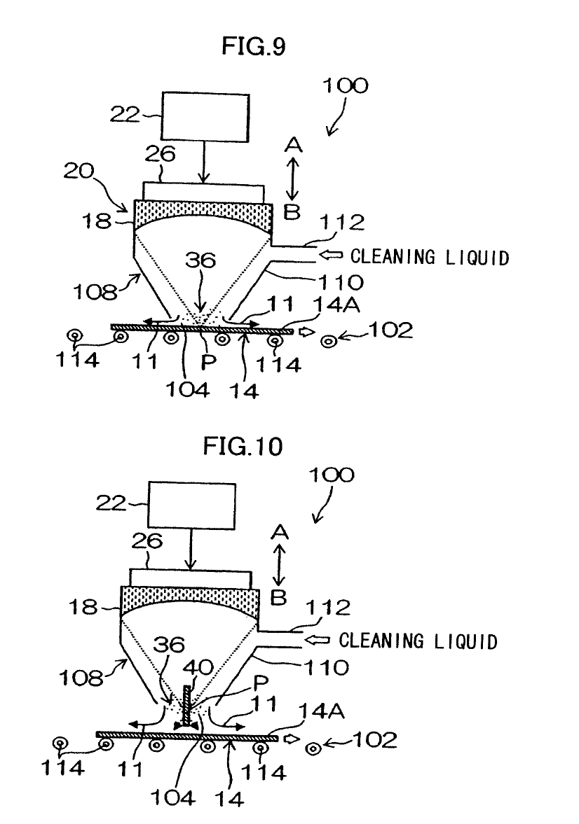

Also in the case of using the ultrasonic-wave-nozzle-type ultrasonic cleaning apparatus, the generation of bubbles can be promoted by providing a solid member 40 at the position P of focusing of ultrasonic waves, as shown in FIGS. 10, 11. Also, it is preferable to incline the direction of ejection of the cleaning liquid 11 from the nozzle 104 and the direction 32 of travel of ultrasonic waves 28 and 30 through an angle α from a direction perpendicular to the surface 14A of the glass substrate 14, as shown in FIG. 11. As the first embodiment, the effective region of ultrasonic waves 28 and 30 in the surface 14A of the glass substrate 14 and the effective region of radicals produced by the ultrasonic waves 28 and 30 can be increased in size thereby. Also, the direction in which the cleaning liquid 11 ejected from the nozzle opening 104 flows along the surface 14A of the glass substrate 14 and the direction of the flow caused by acoustic flow 42 can be set in one direction to enable a contamination removed from the surface 14A of the glass substrate 14 to be quickly expelled from the glass substrate 14, thus improving the cleaning effect. The suitable angle α is the same as that in the first embodiment.

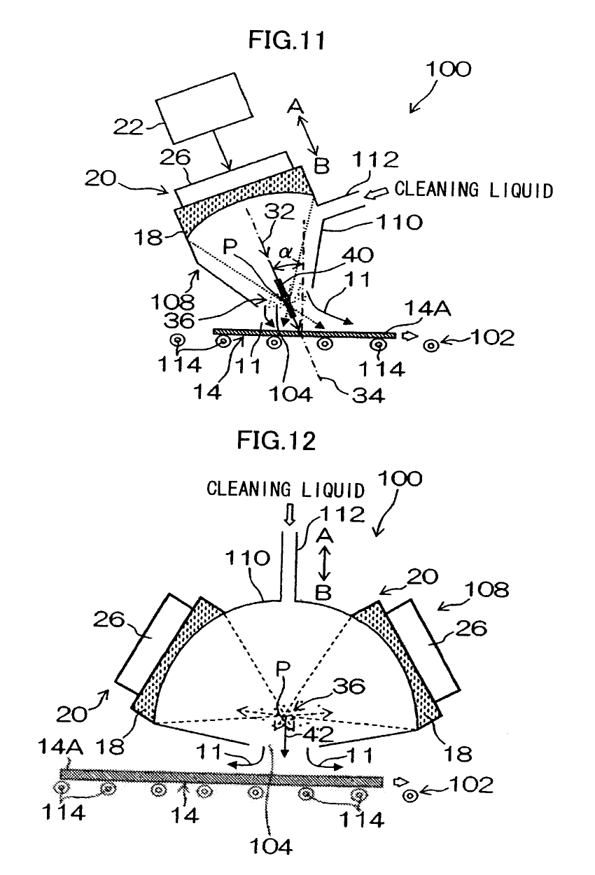

FIG. 12 shows an arrangement in which two ultrasonic wave generation devices 20 are disposed in one ultrasonic wave nozzle 108 in opposition to each other so as to have a common focus point P; a nozzle container 110 is formed into a semi-cylindrical shape that is semicircular in section; and a cleaning liquid supply pipe 112 through which the cleaning liquid 11 is supplied is connected between two ultrasonic vibrators 18. Two ultrasonic wave generation devices 20 are provided so as to have a common focus point P, as described above. This arrangement enables generation of bubbles in a restricted region in the vicinity of the ultrasonic wave 28/30 focus region formed by one ultrasonic wave generation device 20 and thereby makes it possible to obtain further increased energy at the time of collapse of bubbles 36.

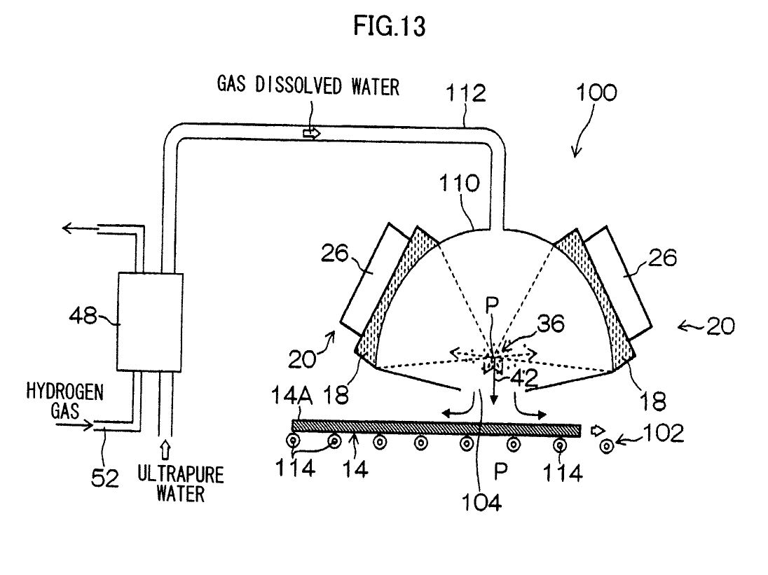

FIG. 13 shows an arrangement in which a gas is blown into the cleaning liquid 11 supplied to the nozzle container 110, and in which a gas dissolving device 48 using a hollow-fiber membrane is provided in an intermediate position in a cleaning liquid supply pipe 112. The gas concentration in the cleaning liquid 11 supplied to the nozzle container 110 is thereby increased to increase the amount of generation of radicals by irradiation with ultrasonic waves 28 and 30, thus further improving the effect of cleaning the glass substrate 14 by radicals.

The embodiments of the present invention have been described with respect to a case where the object to be cleaned is a glass substrate 14 by way of example. However, the object to be cleaned is not limited to a glass substrate 14. The object to be cleaned may be a semiconductor substrate or any other object on which ultrasonic cleaning can be performed.

What is claimed is:

1. A method for ultrasonic cleaning of contamination attached to a surface of an object to be cleaned, comprising the steps of:
providing a cleaning bath with a pool of cleaning liquid therein;
supporting an object to be cleaned on a support base in the cleaning liquid;
generating ultrasonic waves with at least one ultrasonic wave generation device and alternately focusing first ultrasonic waves having a frequency of 1 to 10 MHz and second ultrasonic waves having a frequency equal to or lower than ½ of that of the first ultrasonic waves toward the object to be cleaned;
using a focus position adjustment device to adjust a distance between a focus position of the ultrasonic waves and the surface of the object to be cleaned; and
using a moving device for moving at least one of the ultrasonic wave generation device and the support base in a manner producing a uniform effect of the ultrasonic waves generated by the ultrasonic wave generation device on the surface of the object to be cleaned.

2. Method for ultrasonic cleaning of a contamination attached to a surface of an object to be cleaned, comprising the steps of:
transporting an object to be cleaned with a transport device;
providing at least one ultrasonic wave nozzle above the transport device, and ejecting cleaning liquid from a nozzle opening of the ultrasonic wave nozzle toward a surface of the object to be cleaned, and emitting ultrasonic waves from an ultrasonic wave generation device of the ultrasonic wave nozzle toward the surface of the object to be cleaned, the ultrasonic waves emitted alternately having a first frequency of 1 to 10 MHz and a second frequency equal to or lower than ½ of that of the first frequency; and
adjusting a focus position of the ultrasonic waves with a position adjustment device by adjusting the distance between the nozzle opening and the surface of the object to be cleaned.

3. The method for ultrasonic cleaning according to claim 1, wherein the object to be cleaned is any one of a semiconductor substrate, a glass substrate for an LCD and a photomask.

4. The method for ultrasonic cleaning according to claim 2, wherein the object to be cleaned is any one of a semiconductor substrate, a glass substrate for an LCD and a photomask.

5. The method for ultrasonic cleaning according to claim 1, comprising the step of positioning a solid member at a position to which the ultrasonic waves are focused.

6. The method for ultrasonic cleaning according to claim 2, comprising the step of positioning a solid member at a position to which the ultrasonic waves are focused.

7. The method for ultrasonic cleaning according to claim 1, wherein the solid member is any one of a metallic plate, a flat plate made of a material other than metal, a mesh plate and a porous plate.

8. The method for ultrasonic cleaning according to claim 1, the ultrasonic waves are emitted with a direction of travel that is inclined relative to a direction perpendicular to the surface of the object to be cleaned.

9. The method for ultrasonic cleaning according to claim 2, wherein the cleaning liquid is ejected and the ultrasonic waves are emitted with directions of travel that are inclined from a direction perpendicular to the surface of the object to be cleaned.

10. The method for ultrasonic cleaning according to claim 1, wherein a pair of ultrasonic wave generation devices are provided and are disposed so as to have a common ultrasonic wave focus position.

11. The method for ultrasonic cleaning according to claim 2, wherein a pair of ultrasonic wave generation devices are provided and are disposed so as to have a common ultrasonic wave focus position.

12. The ultrasonic cleaning apparatus according to claim 10, wherein the pair of ultrasonic wave generation devices are supported so as to be rotatable on a rotation axis, comprising the step of using the focus position adjustment device to adjust the distance between the common focus position and the surface of the object to be cleaned by rotating the pair of ultrasonic wave generation devices while maintaining the common focus position.

13. The method for ultrasonic cleaning according to claim 11, wherein the pair of ultrasonic wave generation devices are supported so as to be rotatable on a rotation axis, comprising the step of using the focus position adjustment device to adjust the distance between the common focus position and the surface of the object to be cleaned by rotating the pair of ultrasonic wave generation devices while maintaining the common focus position.

14. The method for ultrasonic cleaning according to claim 1, further comprising the step of using a gas dissolved water blow-in device to blow water in which a gas is dissolved into the cleaning liquid.

15. The method for ultrasonic cleaning according to claim 2, further comprising the step of using a gas dissolved water blow-in device to blow water in which a gas is dissolved into the cleaning liquid.

16. The method for ultrasonic cleaning according to claim 1, further comprising the step of using a gas blow-in device to blow a gas into the cleaning liquid.

17. The method for ultrasonic cleaning according to claim 2, further comprising the step of using a gas blow-in device to blow a gas into the cleaning liquid.
